(19) United States
(12) Patent Application Publication
(10) Pub. No.: US 2018/0231972 A1
(43) Pub. Date: Aug. 16, 2018

(54) SYSTEM FOR PERFORMING TASKS IN AN OPERATING REGION AND METHOD OF CONTROLLING AUTONOMOUS AGENTS FOR PERFORMING TASKS IN THE OPERATING REGION

(71) Applicant: Infinium Robotics Pte Ltd, Singapore (SG)

(72) Inventors: Junyang Woon, Singapore (SG); Weihua Zhao, Singapore (SG); Soon Hooi Chiew, Singapore (SG); Richard Eka, Singapore (SG)

(21) Appl. No.: 15/516,452

(22) PCT Filed: Oct. 2, 2015
(86) PCT No.: PCT/SG2015/050363

§ 371 Date: Apr. 3, 2017

(30) Foreign Application Priority Data
Oct. 3, 2014 (SG) 10201406357Q

(51) Int. Cl. G05D 1/00; G05D 1/08; G08G 5/00; G08G 5/04

(52) U.S. Cl. CPC G05D 1/0027; G05D 1/0808; G08G 5/0069; G08G 5/0008; G08G 5/0021; B64C 39/024; G08G 5/0034; G08G 5/0026; G08G 5/045; B64C 2201/141; B64C 2201/146; G08G 5/0043

(57) ABSTRACT

In a system for performing a task in an operating region, there is a plurality of agents. Each of the plurality of agents has a start position in the operating region and an end position in the operating region. There is a ground control device comprising:
a processor; and
a storage device for storing one or more routines which, when executed under control of the processor, control the ground control device to:
divide the operating region into a plurality of sub-regions based on the start and end positions of the plurality of agents so as to assign ones of the plurality of agents to each sub-region, wherein a number of the ones of the plurality of agents in each sub-region is smaller than a number of the plurality of agents in the operating region;
generate sub-region data of each of the sub-regions; and
generate a plurality of paths of movement based on the sub-region data of the sub-regions for allowing the plurality of agents to move in the operating region to perform the task.

### FIELD OF THE INVENTION

The present invention generally relates to autonomous agents and, in particular, to a system for performing a task in an operating region and method of controlling a plurality of autonomous agents in an operating region.

### BACKGROUND

Single vehicle control problems are well-known by those skilled in the unmanned vehicle arts. However, coordinated movement, or coordination, is a challenging problem in which multiple unmanned vehicles carry out synchronized trajectories for the completion of a defined mission.

Also, there are issues with control of multiple vehicles when operating autonomously. Therefore, it is difficult for vehicles to be navigated in constrained environments, such as indoors, especially in groups. Vehicles may be unable to navigate precisely (e.g., <1 cm) when indoors or outdoors when GNSS signals are weak. Such problems can make it difficult to manage a single vehicle, such as an unmanned aerial vehicle, or UAV. Controlling multiple vehicles precisely can be a hard task. A general problem is how to generate dynamically feasible, collision-free coordination for a large quantity of multiple vehicles. There are many constraints and optimization required to coordinate the vehicles, these include safety constraints between the vehicle, optimization of trajectories to reach a desired position while avoiding collision with other vehicles, and spatial boundaries.

When the number of vehicles increases, the computation effort increases exponentially. This causes activities such as swarming to be infeasible problems to be solved (e.g., it may require days of computation with a powerful workstation). Swarming formation involves a large number of UAVs equipped with basic sensors or payloads. A swarm can include a plurality of agents following probabilistic trajectories. A formation can include a plurality of agents following deterministic trajectories.

Current UAVs tend to rely heavily on space-based satellite global navigation system signals, such as GPS/GLONASS/Galileo (collectively, “GNSS”) for positioning, navigation, and timing services. During peacetime, GNSS can be blocked by buildings in urban area, by terrain or by heavy vegetation. This can lead to inaccurate spatial location even with a clear GNSS signal. For example, a typical GNSS signal can result in 5 to 10 m accuracy, which makes such devices unable to be used indoors, or close to buildings. During periods of hostilities, accurate GNSS signals may be made selectively unavailable by the military.

Employment of multiple sensors in a single UAV can resolve precision problems, but may not solve the computational burdens of coordinating multiple vehicles. Thus, another problem is that a swarming task can be a computationally-heavy multi-vehicle coordination problem. Typically, as the number of UAVs increases, a traditional centralized trajectory generation method becomes computationally infeasible. Conventional UAV control methods have used a decentralized trajectory generation method for a large number of agent (e.g. for more than twenty UAVs). As the information is local, the performance (formation accuracy) is compromised.

### SUMMARY

In an embodiment, there is a system for performing a task in an operating region. The system comprises:
a plurality of agents, wherein each of the plurality of agents has a start position in the operating region and an end position in the operating region; and
a ground control device comprising:
a processor; and
a storage device for storing one or more routines which, when executed under control of the processor, control the ground control device to:
divide the operating region into a plurality of sub-regions based on the start and end positions of the plurality of agents so as to assign ones of the plurality of agents to each sub-region, wherein a number of the ones of the plurality of agents in each sub-region is smaller than a number of the plurality of agents in the operating region;
generate sub-region data of each of the sub-regions; and
generate a plurality of paths of movement based on the sub-region data of the sub-regions for allowing the plurality of agents to move in the operating region to perform the task.

The ground control device may be configured, under control of the processor to divide the operating region by iteratively dividing the operating region to generate a new array of sub-regions.

The ground control device may be configured, under control of the processor to:
analyze dynamics of the ones of the plurality of agents in each sub-region;
define operating envelopes for the plurality of agents based on the sub-region data and the dynamics of the plurality of agents; and
generating a plurality of waypoints for each of the plurality of agents based on the operating envelopes.

The operating envelopes may include spatial constraints of the operating region.

Each of the plurality of agents may include at least one sensor and at least one actuator.

The ones of the plurality of agents may form a cluster of coordinated agents configured to operate to exhibit a behavior in response to the actuator, wherein the behavior is coordinated swarming behavior.

The ones of the plurality of agents may form a cluster of coordinated agents configured to operate to exhibit a behavior in response to the actuator, wherein the behavior is coordinated formation behavior.

The operating region may be a constrained space.

The ground control device may be configured, under control of the processor to receive positional information of each of the plurality of agents.

Each of the plurality of agents may include:
a first communication interface for communicating with the ground control device;
a second communication interface for communicating with neighbouring ones of the plurality of agents;
a controller coupled to the first and second communication interfaces, and including a device identifier code; and
a storage device for storing one or more routines which, when executed under control of the controller, control each of the agents to:
receive a position and a device identifier code of neighbouring ones of the plurality of agents;
calculate a distance and a relative position between one of the plurality of agents and neighbouring ones of the plurality of agents; and
generate a path of movement for the one or neighbouring ones of the plurality of agents based on a priority level associated with each of the plurality of agents.

Each of the plurality of agents may be adapted for handling a payload.

In an embodiment, there is a method of controlling a plurality of autonomous agents in an operating region, the method comprising:
dividing the operating region into a plurality of sub-regions based on the start and end positions of the plurality of agents so as to assign ones of the plurality of agents to each sub-region, wherein a number of the ones of the plurality of agents in each sub-region is smaller than a number of the plurality of agents in the operating region;
generating sub-region data of each of the sub-regions; and
generating a plurality of paths of movement based on the sub-region data of the sub-regions for allowing the plurality of agents to move in the operating region to perform the task.

The method may further comprise iteratively dividing the operating region to generate a new array of sub-regions.

The method may further comprise analyzing dynamics of the ones of the plurality of agents in each sub-region; defining operating envelopes for the plurality of agents based on the sub-region data and the dynamics of the plurality of agents; and generating a plurality of waypoints for each of the plurality of agents based on the operating envelopes.

In the method, the operating envelopes may include spatial constraints of the operating region.

The method may further comprise generating a plurality of coordinated trajectories for the plurality of agents.

In an embodiment, there is an agent controlling device comprising:
a first communication interface for communicating with a ground control device in a system of agents configured for performing a task in an operating region;
a second communication interface for communicating with neighbouring ones of the plurality of agents;
a controller coupled to the first and second communication interfaces, and including a device identifier code; and
a storage device for storing one or more routines which, when executed under control of the controller, control the one of the plurality of agents to:
receive a position and a device identifier code of each neighbouring one of the plurality of agents;
calculate a distance and a relative position between the one of the plurality of agents and the neighbouring one of the plurality of agents; and
generate a path of movement for the one or neighbouring ones of the plurality of agents based on a priority level associated with each of the plurality of agents.

In an embodiment, there is a ground control system for controlling a plurality of agents in a system for performing a task, the ground control system comprising:
a processor; and
a storage device for storing one or more routines which, when executed under control of the processor, control the ground control device to:
divide the operating region into a plurality of sub-regions based on the start and end positions of the plurality of agents so as to assign ones of the plurality of agents to each sub-region, wherein a number of the ones of the plurality of agents in each sub-region is smaller than a number of the plurality of agents in the operating region;
obtain, for generation of a plurality of paths of movement by a path generator, sub-region data of each of the sub-regions.

The ground control system may be, further configured, under control of the processor to iteratively divide the operating region into a new array of sub-regions.

The ground control system may be, further configured, under control of the processor to generate a plurality of paths of movement based on the sub-region data of the sub-regions for allowing the plurality of agents to move in the operating region to perform the task.

The ground control system may be, further configured, under control of the processor to:
analyze dynamics of the ones of the plurality of agents in each sub-region;
define operating envelopes for the plurality of agents based on the sub-region data and the dynamics of the plurality of agents; and
generating a plurality of waypoints for each of the plurality of agents based on the operating envelopes.

In an embodiment, there is an autonomous aerial robot for handling a payload in a system comprising a plurality of autonomous aerial robots configured for receiving instructions from a ground control system for performing a task in an operating region, the autonomous aerial robot comprising:
a support member adapted for handling a payload;
a first communication interface for communicating with a ground control device;
a second communication interface for communicating with neighbouring ones of the plurality of robots;
a controller coupled to the first and second communication interfaces, and including a device identifier code; and
a storage device for storing one or more routines which, when executed under control of the controller, control the autonomous aerial robot to:
receive a position and a device identifier code of the neighbouring ones of the plurality of robots;
calculate a distance and a relative position between the autonomous aerial robot and each of the neighbouring ones of the plurality of robots; and
generate a path of movement for the autonomous aerial robot based on a priority level associated with each of the plurality of robots.

The autonomous aerial robot may comprise at least one sensor and at least one actuator.

The at least one sensor may be a force sensor for detecting a change in a weight of the autonomous aerial robot, wherein the autonomous aerial robot may be configured, under control of the controller, to generate or reduce a lift-up force to compensate the change in the weight.

### BRIEF DESCRIPTION OF THE DRAWINGS

In order that embodiments of the invention may be fully and more clearly understood by way of non-limitative examples, the following description is taken in conjunction with the accompany drawings in which like reference numerals designate similar or corresponding elements, regions and portions, and in which:

FIG. 1 is a diagram illustrating an exemplary system for performing a task in an operating region;

FIG. 2 is a diagram illustrating a path of movement (trajectory) of an agent;

FIG. 3 is a block diagram illustrating components of a ground control device;

FIG. 4 is a block diagram illustrating components of an agent;

FIG. 5 is a block diagram illustrating components of an on-board controller of the agent of FIG. 4;

FIG. 6 is a flow chart illustrating a method of controlling a plurality of autonomous agents in an operating environment;

FIG. 7 is a process flow diagram illustrating a method of reducing computational data for processing by a path generator;

FIG. 8 is a flow chart illustrating a method of flexible spatial region divider (FSRD) to obtain sub-region data;

FIG. 9 is a Voronoi diagram illustrative of a region and sub-regions generated by the method (FSRD) of FIG. 13;

FIG. 10 is a process flow diagram illustrating a method of controlling a plurality of autonomous agents;

FIG. 11 is a flow chart illustrating a method of controlling a plurality of autonomous agents;

FIG. 12 is a process flow diagram illustrating a method of controlling a plurality of autonomous agents;

FIG. 13 is a flow chart illustrating a method of controlling a plurality of autonomous agents by performing a Full Dynamics Envelope Analysis (FDEA); and

FIG. 14 is a flow chart illustrating a detailed method of controlling a plurality of autonomous agents by performing a Full Dynamics Envelope Analysis (FDEA).

FIG. 15A is a side view of an autonomous aerial robot;

FIG. 15B is a top view of the autonomous aerial robot of FIG. 5A;

FIG. 16 is a top view of a support structure for an autonomous aerial robot;

FIG. 17 is a block diagram of an MPC formation flight planner with attitude adaptive control;

FIG. 18 is a graphical illustration of forward, backward, and safe operating reachable states;

FIG. 19 is a flow chart illustrating a method for determining states constraints;

### DESCRIPTION

While exemplary embodiments pertaining to the invention have been described and illustrated, it will be understood by those skilled in the technology concerned that many variations or modifications involving particular design, implementation or construction are possible and may be made without deviating from the inventive concepts described herein.

In the following embodiment, there is an autonomous agent and a system of autonomous agents capable of coordinated motion in a constrained space and to achieve single or multiple missions (such as, but not limited to, delivering of payloads to a plurality of destinations). An agent is defined as an autonomous object which may include, but not limited to, robots, unmanned aerial or ground vehicles.

As used herein, the term “agent” can indicate a ground-based, water-based, air-based, or space-based vehicle that is capable of carrying out one or more trajectories autonomously and capable of following positional commands given by actuators. Here, “aircraft” may be used to describe a vehicle with a particular characteristic of agent motion, such as “flight.” In general, “aircraft” and “flight” are terms representative of an agent, and agent motion, although specific types of agents and corresponding motion may be substituted therefor, including ground- or space-based agents. A “payload” is the item or items carried by an agent, such as dishes in a restaurant or packages in a warehouse. In addition, the term payload can signify one or more items that an agent carries to accomplish a task including but not limited to conveying dishes in a restaurant, moving packages in a warehouse, inspection of vehicles (aircraft, automobiles, ships) in an inspection area, and delivering or executing a performance. Further, as used herein, a performance can be a show or display accomplished by maneuvering multiple agents, in combination of music, lighting effects, other agents, or the like.

Many constraints in space and time may be imposed upon an agent. A spatial constraint can be the space of the performance area, or the venue of payload delivery, or any obstacles, pre-existing or emergent. A time constraint can be the endurance of each agent for one full-charged battery, minus the required time to return to a base station. For example, after finishing a mission, the agent will go back to its base station to be charged while waiting for the next mission. The base station is a charging pad which will charge the agent automatically whenever there is an agent on top of it. The base station may contain additional visual cues, so that the agent can align itself to the base.

The term “coordination” means a technique to control complex multiple agent motion by generating trajectories online and offline, and the implementation of the respective trajectories for agents. Coordinated movement is accomplished by following the trajectories generated for multiple agents to collectively achieve a mission or performance requirement, and at the same time be collision free. Coordination can include synchronized movement of all or some agents.

According to the embodiments of the invention, a given spatial region may be divided into several computationally feasible regions such that the agent trajectories can be generated. Also the agent trajectories have taken into consideration the full dynamics of the agents.

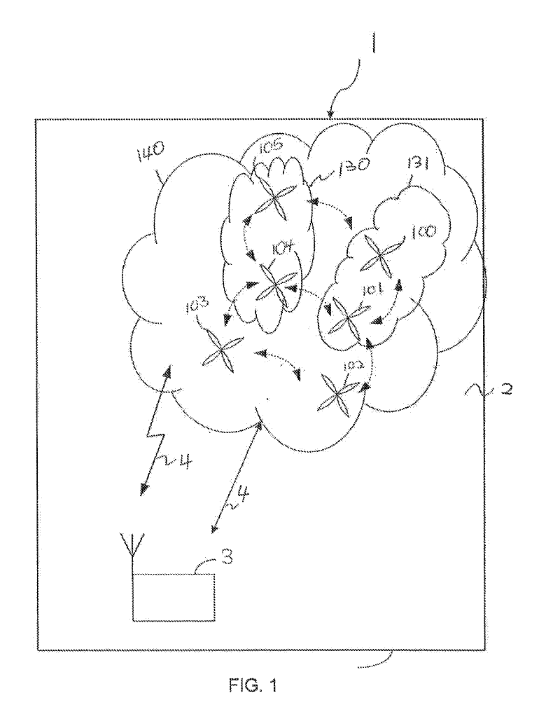

FIG. 1 is a diagram illustrating an exemplary system 1 for performing a task in an operating region 2. Referring to FIG. 1, the system 1 comprises a plurality of agents 100-105, and a ground station 3 or a ground control device 3 for controlling the plurality of agents 100-105. The ground station 3 is coupled to the plurality of agents 100 to 105 through a communication interface, such as a data communication link 4. The data communication link 4 can be encrypted and frequency hopping transmission can be used to minimize inter-signal interference.

The agents may be under central control or distributed (decentralized) control. Central control can be performed by controlling an agent 100, a cluster 130, or a fleet 140 of agents 100-103 via the ground control station 3 which acts as a central ground station. The user may input the destination and define an end position of an agent in the operating region 2 from either the ground control station 3 or other device that is connected to the ground control station. A task or a mission may be given when the agent is in a base station or while it is doing another mission (replace the current mission). Distributed control can be performed by sending in advance, the mission objectives to every individual agent 100-103, or selected agents, and by allowing the individual agent to act on its own, while cognizant of and responsive to, other agents. A mission objective can be updated from time to time, if the need arises.

In an embodiment, the agent 100-105 may be a quadcopter having 6 DOF. Flight control and communication messages sent between the agents and the ground control station 3 can be encoded and decoded according to certain protocols, for example, a MAVLink Micro Air Vehicle Communication Protocol (“MAVLink protocol”) which is a known protocol. The MAVLink protocol can be a very lightweight, header-only message marshalling library for micro air vehicles that serves as a communication backbone for the MCU/IMU communication as well as for interprocess and ground link communication. In a centralized communication and control approach, the MAVLink protocol can be communicated among ground station 3 and the agents 100-105.

Alternately, the agents or quadcopters 100-105 may communicate among themselves using the MAVLink protocol in a distributed communication and control approach. Each of the plurality of agents 100-105 can be exemplified by a robot (ground or flying) that is capable of carrying out trajectories autonomously. Agents 100-105 can be representative of a cluster of agents that are capable of executing program commands enabling to maneuver both autonomously and in coordination. A group of two or more agents 100, 101 can be a cluster 130, and one or more clusters 130, 131 can be called a fleet 140. There may be clusters of clusters 130 in fleet 140, and each cluster 130 may have a different number of agents 100-104. Alternatively stated, fleet 140 may be those clusters of agents 100-103 responsible for payload delivery, or those agents 100-103 engaged in a performance. Agent 100 may move from one cluster 130 to another 131.

The system 1 may be configured to enable the control of multiple agents to continuously deliver payloads into several destinations at the same time. For example, the ground station 3 can be used to monitor, and possibly manage, entire fleet 140 of agents 100-103. The agent 100 may be controlled by a ground station 3, by a cluster or agents 130, or by another agent 101. Typically, the constitution and number of agents 100-103 can be grouped into one or more clusters 130, which may have a different number of agents depending upon the requirements of the payload delivery or performance ordered. An agent system can be defined by a preselected number of agents 100-103 from fleet 140. As GNSS-only agents are prone to jamming or signal degradation, a typical agent 100 can have multiple sensors to provide redundancy and added accuracy.

Each of the plurality of agents 100-105 has a start position and an end position in the operating region 2 which define a path of movement or trajectory for each agent. The trajectory may be assigned to each individual agent by the ground station 3, or may be pre-loaded to the on-board computer of the agent. When the trajectories are pre-loaded in a preselected motion mode, the trajectories given by the preselected motion mode comprise of a time vector and a corresponding vector of spatial coordinates. The trajectory, for example, may be a plurality of related spatial coordinate and temporal vector sets. Each individual trajectory of an agent 100-106 can include temporal and spatial vectors that are synchronized to the trajectories of other ones of the agents 100-106. This synchronization may provide collision free movement.

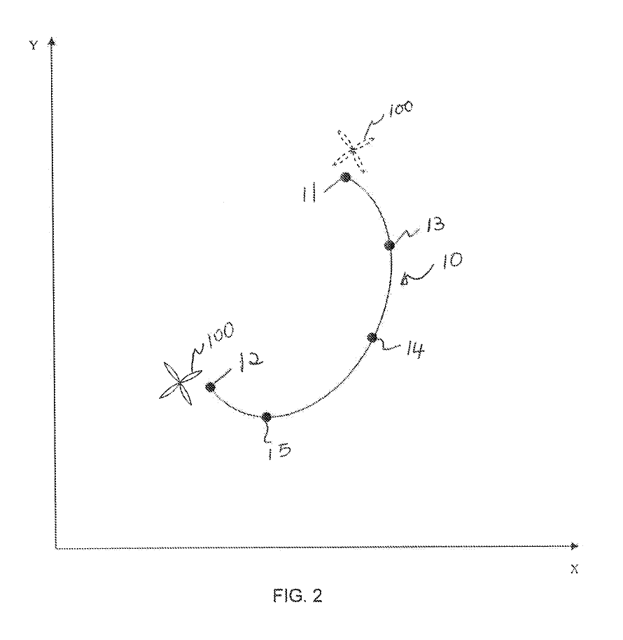

FIG. 2 is a diagram illustrating a path of movement 10 (trajectory 10) of the agent 100 having a start position 11 and an end position 12 in the operating region 2. The trajectory 10 for an agent can be pre-loaded onto an agent onboard computer, or broadcast from the ground station 3. The trajectory 10 can be formed from a set of waypoints 13, 14, 15, along the path of movement 10. In the case of central control, a waypoint 13-15 is updated by the ground station 3. For distributed control, a pre-loaded waypoint may be utilized, but can be updated by ground station should the need arise. The trajectories can be modified real time for higher priority task, such as to avoid collision.

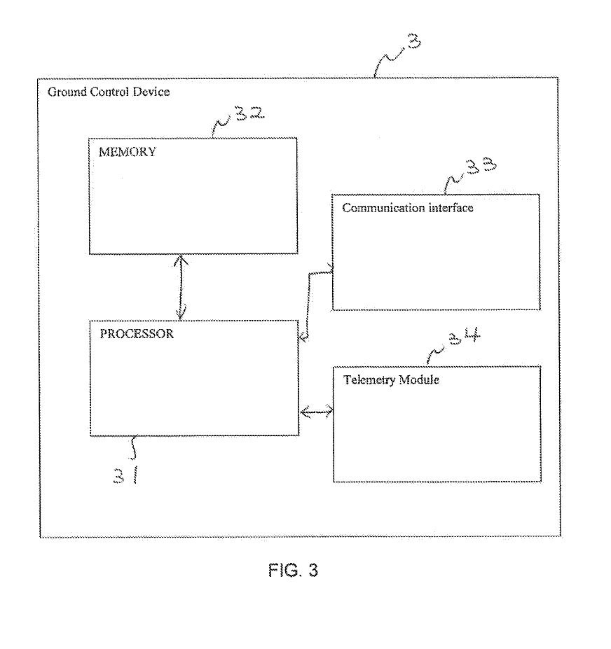

FIG. 3 is a block diagram illustrating components of a ground control device 3. The ground control device 3 comprises a processor 31 coupled to a storage device 32 (such as a memory). The ground control device 3 may have a communication interface 33 for communicating with the agents 100-105, and a telemetry module 34. The telemetry module 34 may include, for example, XBee DigiMesh 2.4 RF Module or a Lairdtech LT2510 RF Module. XBee DigiMesh 2.4 embedded RF modules utilize the peer-to-peer DigiMesh protocol in 2.4 GHz for global deployments are available from Digi International® Inc., Minnetonka, Minn. USA. Lairdtech LT2510 RF 2.4 GHz FHSS (frequency-hopping spread-spectrum) modules are available from LAIRD Technologies®, St. Louis, Mich. USA. The ground station 3 can be a workstation or central computer that is used as a supervisor or command center. The ground station 3 can be a Windows®, Linux®, or Mac® operating system environment. Ground station 3 may employ Simulink to communicate with telemetry module 34 and thus with the agents 100-105. Simulink, developed by MathWorks, Natick, Mass. USA, is a data flow graphical programming language tool for modeling, simulating and analyzing multidomain dynamic systems. In centralized case, it broadcasts commands to all agents at a fixed interval (e.g., between about 1 Hz to about 50 Hz). For decentralized mode, the ground station 3 acts as a supervisor that broadcasts mission update periodically.

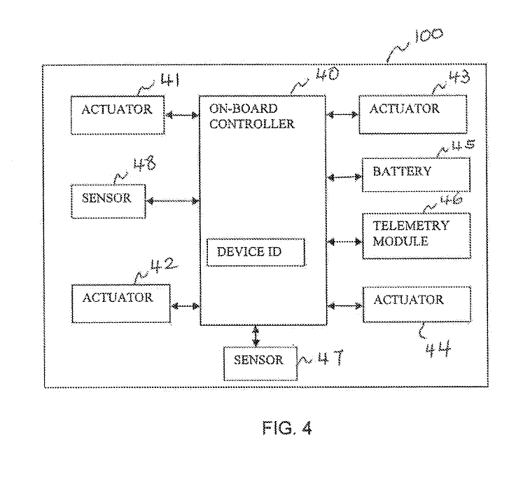

FIG. 4 is a block diagram illustrating components of an agent 100. It will be appreciated that the agents 101-105 may have similar components and therefore will not be described. The agent 100 comprises an on-board controller 40 coupled to a plurality of actuators 41-44, a battery 45, a telemetry module 46, and a plurality of sensors 47-48.

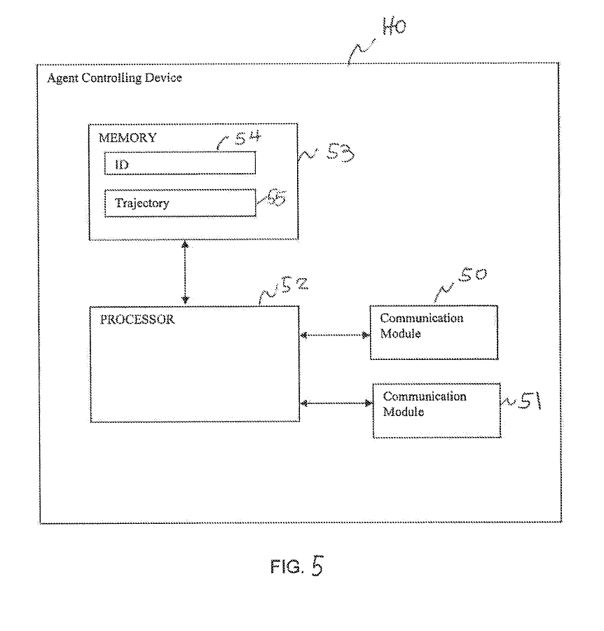

FIG. 5 is a block diagram illustrating components of the on-board controller 40 or an agent controlling device 40 for the agent 100. The agent controlling device 40 has a first communication interface 50 for communicating with a ground control device 3 and a second communication interface 51 for communicating with neighbouring ones 101-105 of the plurality of agents. A processor 52 is coupled to the first and second communication interfaces 50, 51, and a storage device or a memory 53 storing a device identifier code 54 which is an unique identification code for identifying the agent 100 and a trajectory 55 which the agent 100 has been assigned to follow in a path of movement to complete a task.

The memory 53 also stores one or more routines which, when executed under control of the processor 52, control the agent 100 to:
(i) receive a position and a device identifier code of each neighbouring one 101-105 of the plurality of agents;
(ii) calculate a distance and a relative position between the agent 100 and each neighbouring one 101-105 of the plurality of agents; and
(iii) generate a path of movement for the one or neighbouring ones of the plurality of agents based on a priority level associated with each of the plurality of agents.

The memory 53 may also store routines which, when executed under control of the processor 52, control the agent 100 to perform communication, acquire positioning data and attitude estimation, perform sensor reading, calculate feedback control, and send commands to actuators 41-44 and, perhaps, one or more other agents 101-103.

After the destination of each agent has been set by a user in the system 1, the ground control device 3 will calculate the optimized path for the respective agent. This path will be stored in the memory 32 as a reference, as well as uploaded into the agent's on-board controller (as shown in FIG. 4) to be followed by the agent 100-105. Depending on an environment or operating region of the agents, the paths taken to reach the destination, and goes back to base may be predefined. There may be various combinations of paths that can be used to allow the agents reach the desired destinations. The ground control station 3 may be configured to select the most optimized path based on factors such as the total distance needed to travel, how crowded the path is, as well as the presence of dynamic disturbances as alerted by other agents in that vicinity, for example, when the environment is already known.

The memory 32 of the ground control device 3 stores one or more routines which, when executed under control of the processor 31, control the ground control device 3 to:
divide the operating region into a plurality of sub-regions based on the start and end positions of the plurality of agents so as to assign ones of the plurality of agents to each sub-region, wherein a number of the ones of the plurality of agents in each sub-region is smaller than a number of the plurality of agents in the operating region;
generate sub-region data of each of the sub-regions; and
generate a plurality of paths of movement based on the sub-region data of the sub-regions for allowing the plurality of agents to move in the operating region to perform the task.

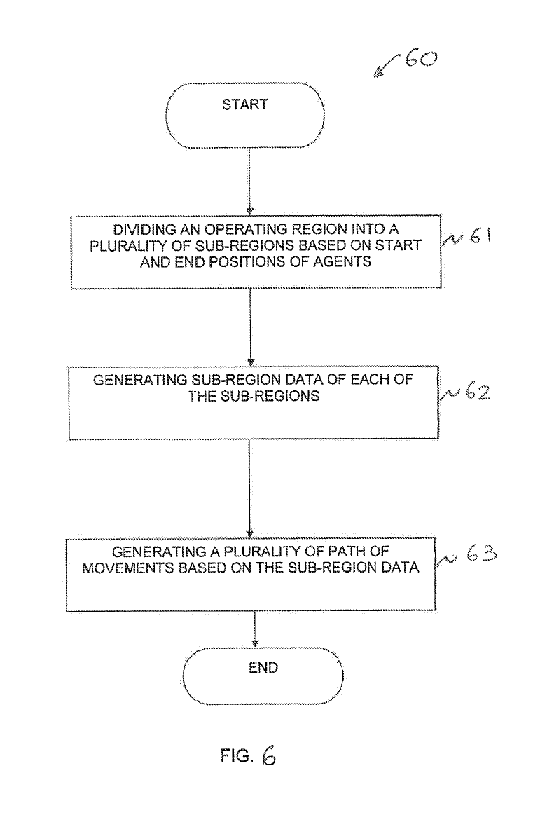

When the paths are not predefined, the ground control station 3 may have a path generator to generate a path of movement for each agent. The complexity of a generated path increases exponentially with respect to the number of agent involved. To reduce computing complexity, a method 60 of controlling a plurality of autonomous agents in the operating region according to an embodiment is illustrated in a flow chart of FIG. 6. Based on the method 60, the operating region or a spatial region may be intelligently divided into several sub-regions. In step 61, the operating region is divided into a plurality of sub-regions based on the start and end positions of the plurality of agents so as to assign ones of the plurality of agents to each sub-region. After dividing, a number of the ones of the plurality of agents in each sub-region is smaller than a number of the plurality of agents in the operating region. Sub-region data of each of the sub-regions is generated at step 62 and a plurality of paths of movement based on the sub-region data of the sub-regions for allowing the plurality of agents to move in the operating region to perform the task are generated at step 63.

The method 60 may also be a Flexible Spatial Region Divider (FSRD) module stored in a non-transitory computer recordable medium, which when executed under control of a processor, controls a ground control station to divide one operating region (large area) into several sub-regions (smaller areas than the region) in which each sub-region may be occupied by one or more agents. The path for agents in one sub-region will not cross to the other sub-region. Each sub-region is flexible in that the size of the region and the number of agents in a sub-region may be modified. For example, when modifying the sub-region and the corresponding sub-region data including its position, size, and number of the agent inside may be modified.

By dividing one big region into several sub-regions, the number of the agents that are calculated by a path generator or a navigation system may be reduced, hence reducing the computational time. The method 60 may be used to convert a computationally-heavy multi-agent coordination problem into a computationally-feasible one while addressing the robustness issue, and can be employed in the optimization process to intelligently divide the multiple agent operation space into smaller regions, which enables the optimization process to be feasible and real-time. Under the method 60, the whole centralized formation flight problem is divided into decentralized subsystems. One major advantage of this method 60 is that the closed-loop stability of the whole formation flight system is always guaranteed even if a different updating sequence is used, which makes the scheme flexible and able to exploit the capability of each agent fully. The obstacle avoidance scheme in formation flight control can be accomplished by combining the spatial horizon and the time horizon, so that the small pop-up obstacles avoidance is transformed into additional convex position constraint in the online optimization.

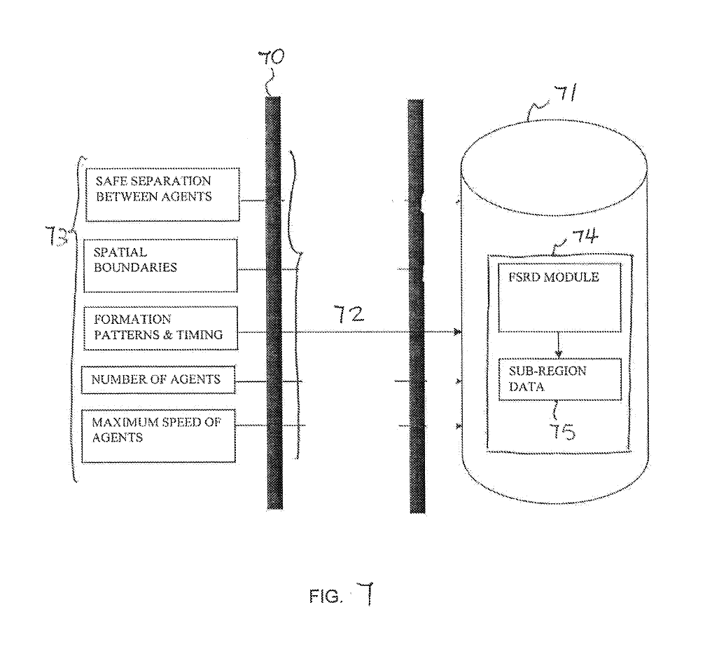

FIG. 7 is a process flow diagram illustrating an exemplary interaction and data exchange between an input terminal 70 and a ground control system 71 configured to reduce computational data for processing by a path generator in an embodiment. In exchange 72, inputs including constraints 73 are identified and sent to the ground control system 71 for processing by a processor 74 to generate sub-region data 75 for processing by a path generator. The constraints may include safe separation between agents, spatial boundaries, formation patterns and timing, number of agents, and maximum speed of agents. The processor 74 may be configured to execute a method 700 of flexible spatial region divider (FSRD) to obtain sub-region data according to an embodiment.

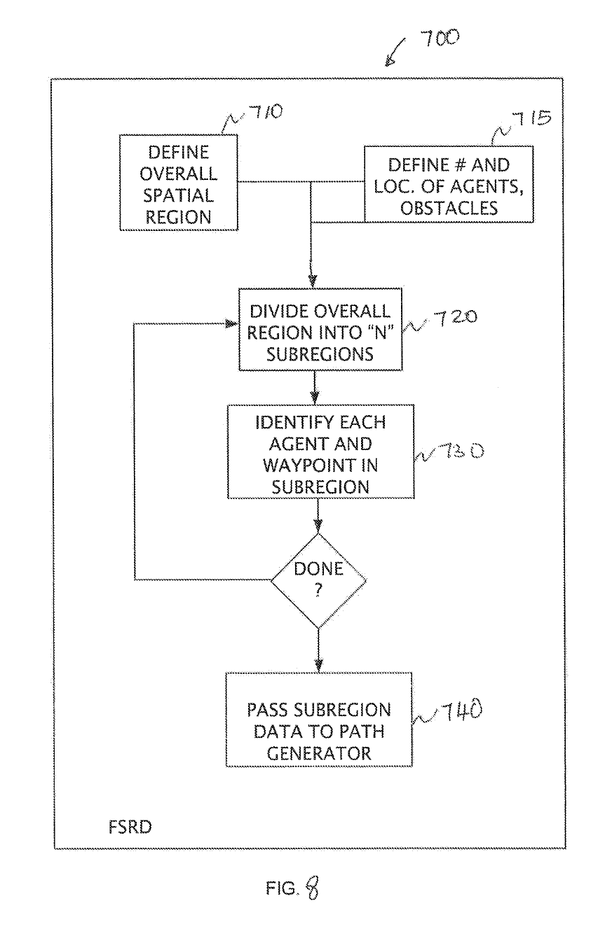

Referring to FIG. 8, according to the method 700, the overall spatial region of interest may be divided into sub-regions such that the computational costs for a next step, such as analyzing of collision avoidance for path generation may be reduced, especially when large number of agents is involved. In the method 700, the overall spatial region is defined at step 710 by the user. Other inputs such as number of agents, obstacles are also defined at step 715 by the user. The overall region may be divided at step 720 into several sub-regions with each sub-region including of a much smaller number of agents and each agent and its waypoint in each sub-region is identified to generate sub-region data or information at step 730. Each sub-region information is then passed at step 740 to a path generator so that the sub-region data of each sub-region can be processed separately by a path generator to generate collision-free trajectories forming paths of movement of the agents.

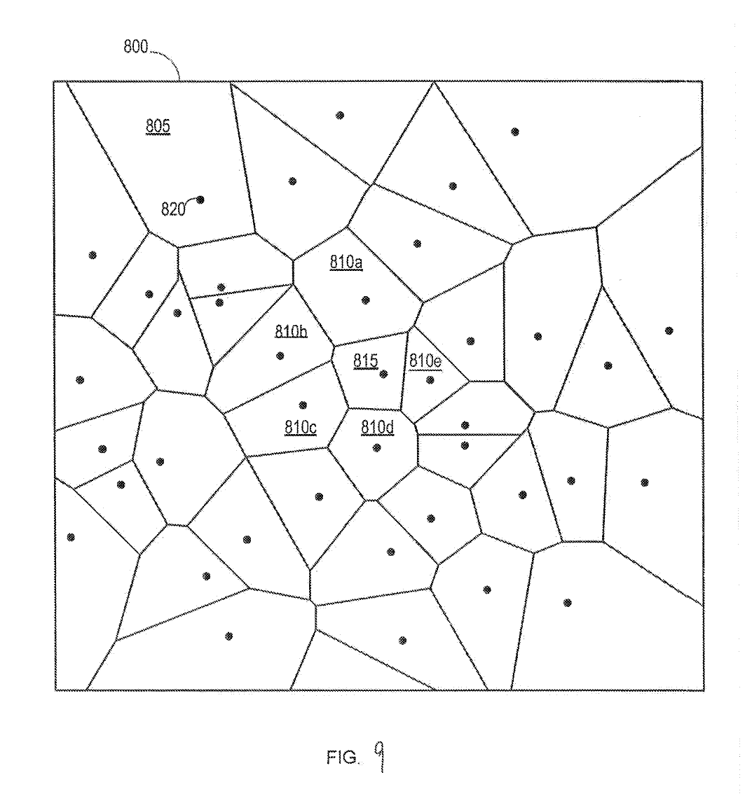

FIG. 9 illustrates a Voronoi diagram of a predetermined spatial region 800. A Voronoi diagram is also referred to as Dirichlet tessellations, and the cells are called Dirichlet regions, Thiessen polytopes, or Voronoi polygons. Mathematically, consider a collection of n>1 agents in a convex polytope Ω, with pᵢ ∈Q denotes the position of the agents. A set of regions (P)={Vᵢ, . . . , Vₙ}, Vᵢ⊂ Q is the Voronoi partition, generated from the set [symbol] ={pᵢ, . . . , pₙ} if Vᵢ={q∈Q: ∥q−pᵢ∥<∥q=pⱼ∥, ∀j≠i} where ∥·∥ is the Euclidean norm. If pᵢ is the (Voronoi) neighbor of p₁ or vice versa, the Voronoi partitions Vᵢ and Vⱼ are adjacent and share an edge. The edge of a Voronoi partition is defined as the locus of points equi-distant to the two nearest agents. The Voronoi neighbors of pᵢ is denoted by [symbol] (i); and j∈ [symbol] (i) if and only if i∈ [symbol] (j). Two agents are neighbors if they share a Voronoi edge. An agent would decide which agents within its sensing range to interact with based on the Voronoi diagram.

In some embodiments, at every iteration, a new Voronoi diagram may be generated. In the representation in FIG. 9, overall spatial region 800 can be divided into a plurality of sub-regions (collectively at 805). For the clarity of presentation, each of the plurality of sub-regions 805 can be populated with one agent 820, represented by a dot. Selected sub-regions 810a-810e can be identified as neighboring regions of preselected region 815. A new divider can be drawn to flexibly divide the overall spatial region into a new array of sub-regions. For example, the first sub-region may be divided from a corner of the overall spatial region, and the neighboring regions may be sub-divided until all regions are covered. In one embodiment, each sub-region is populated with six agents. However, the number of sub-regions and agents in a subregion may be modified based on a computational power of the ground control system or a work station performing the functions of the ground control system. The method may include determining sub-regions boundaries based on a Voronoi partition.

A path generator of a different ground control system may be configured to receive and process, sub-region data or the boundaries information of the sub-regions generated by the ground control system 71 according to the method 700, together with the waypoints of the missions/shows, the safe distance between agents, and the maximum speed of the agents to generate the collision-free trajectories.

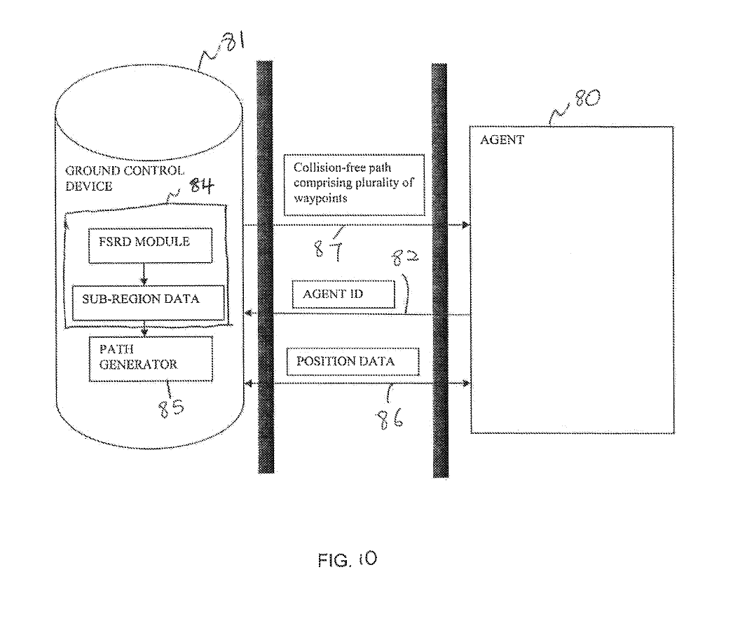

FIG. 10 is a process flow diagram illustrating an exemplary interaction and data exchange between an agent 80 of a plurality of agents and a ground control device 81. In exchange 82, an agent ID of the agent 80 is identified and sent to the ground control device 81 for processing by a processor 84 to generate sub-region data for processing by a path generator 85. In exchange 86, position data of the agent may be sent to the ground control device 81, or the ground control device 81 may send position data of other agents to the agent 80. In exchange 87, a collision-free path comprising a plurality of waypoints may be generated and sent to the agent 80.

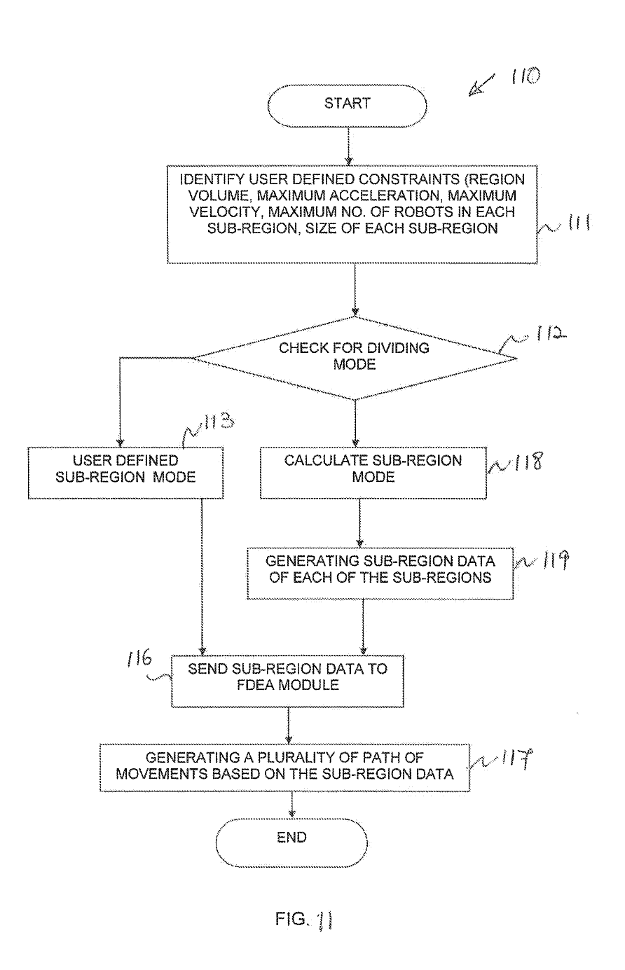

FIG. 11 is a flow chart illustrating a method 110 of controlling a plurality of autonomous agents. The processor 84 may be configured to execute a method 110 to obtain sub-region data according to an embodiment. Referring to FIG. 11, the method 110 comprises identifying user defined constraints (region volume, maximum acceleration, maximum velocity, maximum number of agents/robots in each-sub-region, size of each sub-region at step 111. In step 112, a dividing mode (mode for dividing a region or sub-region) is determined. If it is determined to be a user defined sub-region mode at step 113, sub-region data is sent at step 116 for performing full dynamics envelope analysis (FDEA) at step 116 and to generate a plurality of paths of movements based on the sub-region data at step 117. If it is determined to be a mode to calculate a sub-region in step 118, sub-region data of each sub-region is generated at step 119, and sent to step 116 for performing full dynamics envelope analysis (FDEA) at step 116 and to generate a plurality of paths of movements based on the sub-region data at step 117.

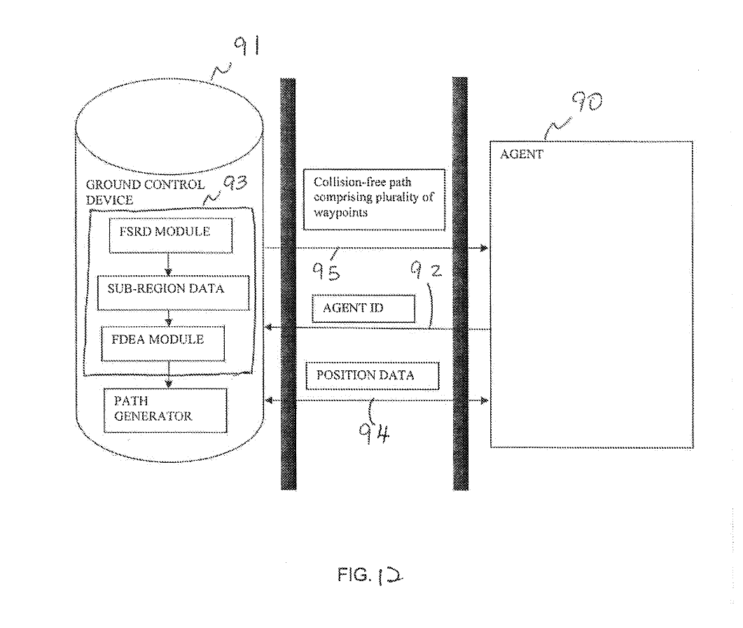

FIG. 12 is a process flow diagram illustrating an exemplary interaction and data exchange between an agent 90 of a plurality of agents and a ground control device 91. In exchange 92, an agent ID of the agent 90 is identified and sent to the ground control device 91 for processing by a processor 93 to generate sub-region data. In exchange 94, position data of the agent 90 may be sent to the ground control device 91, or the ground control device 91 may send position data of other agents to the agent 90. In exchange 95, a collision-free path comprising a plurality of waypoints may be generated and sent to the agent 90.

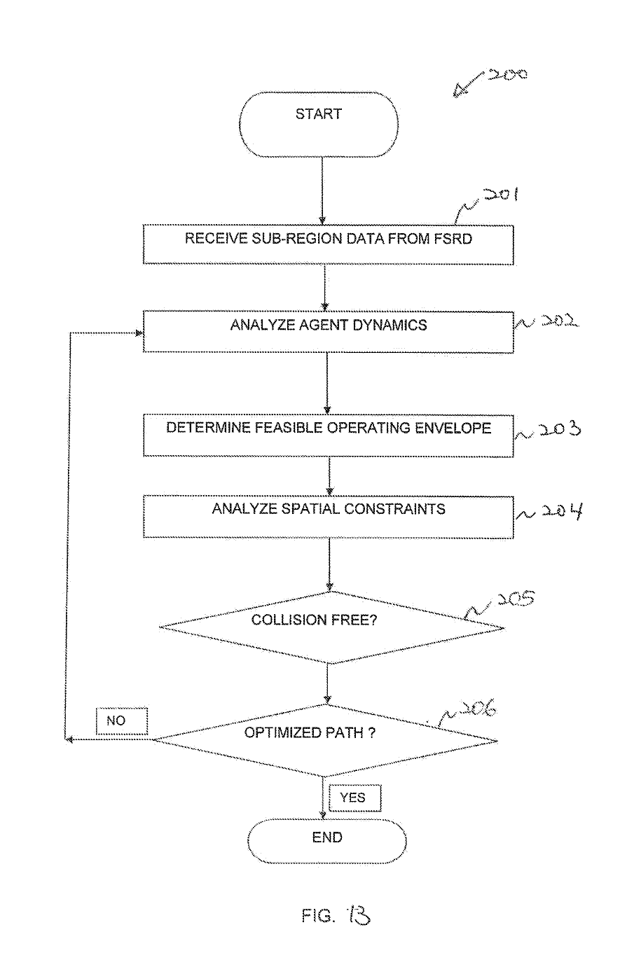

FIG. 13 is a flow chart illustrating a method 200 for performing a Full Dynamics Envelope Analysis (FDEA). The method 200 comprises receiving sub-region data from an earlier process according to the method 60 of FIG. 6, at step 201. Each sub-region data or information describes the spatial region boundaries, and the number of agents in that sub-region. In addition, the dynamics of agents, i.e. maximum allowable speed, maximum allowable acceleration, and other constraints as defined by the users (“agent dynamics”) are analysed at step 202. The mission/show waypoints together with the timings may also analysed in step 202. A feasible operating envelope is determined in step 203. Spatial constraints are analysed in step 204. If it is determined in step 205 that a path of an agent is collision free and is determined to an optimized path in step 206, the optimized path is assigned to the agent. An optimized path may mean, a path of movement in which an agent moves from one point to another point in the shortest time to perform a task, and the path of movement is a collision-free trajectory comprising a plurality of waypoints. However, if the path is not an optimized path, the method 200 returns to step 202 for analysis of the agent dynamics. Based on the method 200, the outputs may include the trajectories (a list of waypoints at fixed time-step, between 1 Hz and 50 Hz or more, depending on the scenario requirements) for each agent. These waypoints may be broadcast to agents from a ground control device or system, or uploaded to the agents' onboard computer or controller directly.

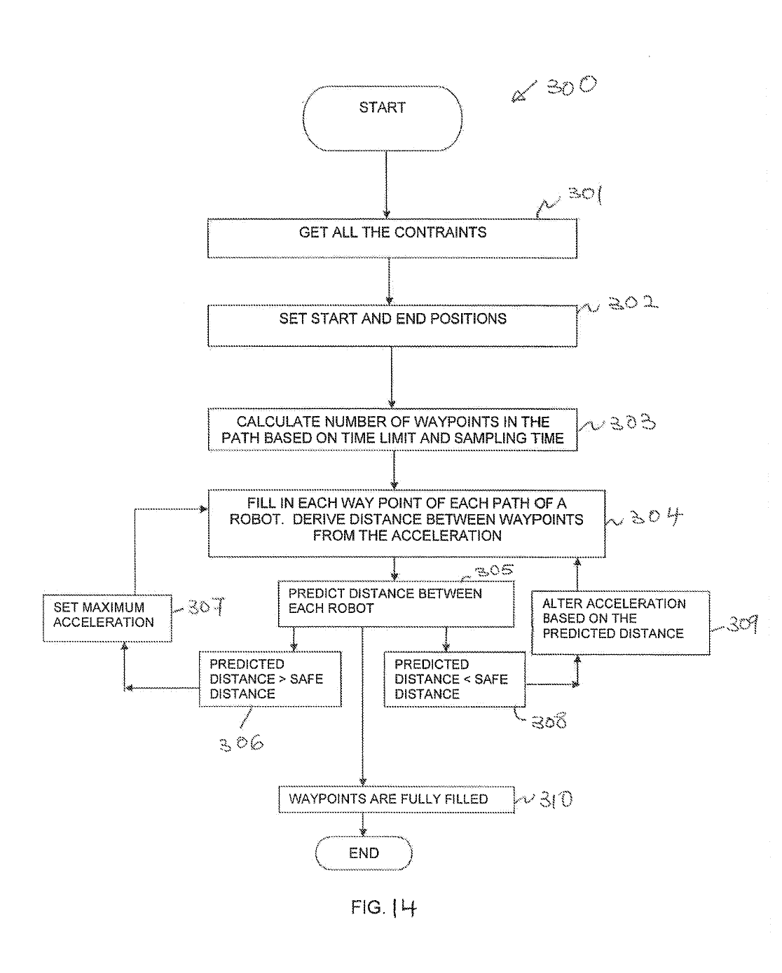

FIG. 14 is a flow chart illustrating a method 300 for performing a Full Dynamics Envelope Analysis (FDEA) for controlling a plurality of autonomous agents in an operating region. All the constraints of an operating region is obtained in step 301 and start and end positions of the agents are determined in step 302. A number of waypoints in each of the paths of the agents is calculated based on a time limit and sampling time of each agent in step 303. Each way point of each path of a agent is filled and a distance between waypoints is derived based on an acceleration of the agent in step 304. A distance between each agent or robot is predicted in step 305. If it is determined in step 306 that the predicted distance is more than a safe distance (collision free distance), a maximum acceleration is set for the agent in step 307 and returns to steps 304 and 305. If it is determined in step 308 that the predicted distance between each agent is less than a safe distance, an acceleration of the agent is altered in step 309 based on the predicted distance in step 308, and returns to steps 304 and 305. The method 300 terminates when the waypoints are fully filled in step 310.

Based on the above methods, the waypoints are generated at a fixed time step. The time step can be changed depends on the requirement (when the agent is moving at high speed, high frequency is needed. However, it will require more computational power as well. At the same time, the dynamics of the agents are taken into account to generate feasible trajectories for large number of agents in a computationally efficient manner either offline or real-time. In an embodiment, the above described methods may further comprise include a step of defining a “problem descriptor” corresponding to definitions of spatial boundaries, safety distance between agents, waypoints, and dynamics of agents.

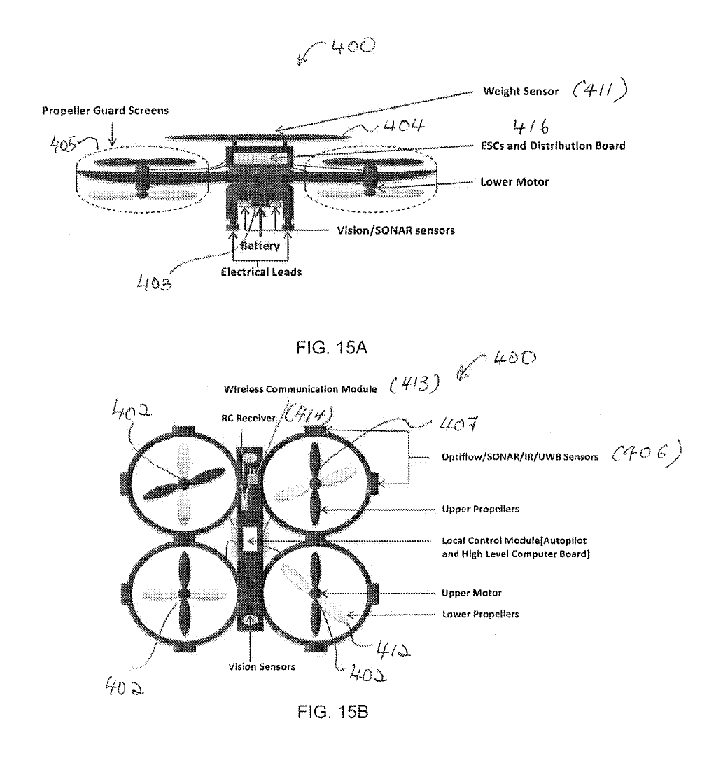

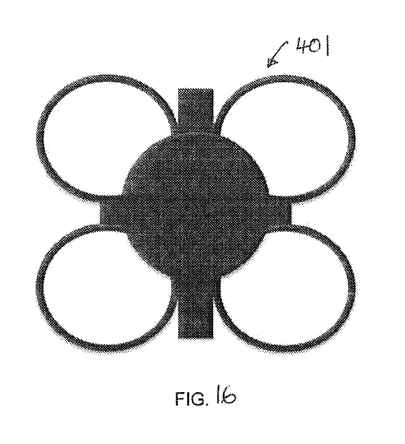

FIG. 15A is a side view of an autonomous aerial robot 400 for handling a payload in a system comprising a plurality of autonomous aerial robots configured for receiving instructions from a ground control system for performing a task in an operating region. FIG. 15B is a top view of the autonomous aerial robot 400. FIG. 16 is a top view of a frame 401 for an autonomous aerial robot 400. The robot 400 comprises a plurality of actuators 402 and is autonomously capable of following positional commands delivered by actuators. The autonomous aerial robot 400 is powered by a battery 403, and comprise a support member 404 adapted for handling a payload.

The battery 403 comprises electrical leads connected to landing gears located at a lowest part of the robot 400). The electrical charging leads may be adapted to connect to autonomous charging plates when it is resting on the plate as part of the charging/base station in order to charge the batteries (that is already strapped to the robot). Hence there is no need for human involvement to remove and charge the batteries.

The robot 400 has propeller guard screens 405 covering upper and lower propellers 407, 412, and corresponding motors mounted to drive the propellers. There are two communication modules on the robot 400. One is used to communicate with a ground control station, while the other is to communicate with other robots similar to the robot 400 (“agents”). Both modules are two way communication modules. Specifically, there is a first communication interface 413 for communicating with a ground control device, and a second communication interface 414 for communicating with neighbouring ones of the plurality of robots. The robot 400 has a controller 416 coupled to the first and second communication interfaces, and a storage device storing a device identifier code, and one or more routines which, when executed under control of the controller, control the autonomous aerial robot to:
receive a position and a device identifier code of the neighbouring ones of the plurality of robots;
calculate a distance and a relative position between the autonomous aerial robot and each of the neighbouring ones of the plurality of robots; and
generate a path of movement for the autonomous aerial robot based on a priority level associated with each of the plurality of robots.

The autonomous aerial robot may comprise at least one sensor 406 and a weight sensor 411. In an embodiment, the weight sensor may be mounted to the top of the robot as shown in FIG. 15A. However, if the payload was handled from below the robot, the weight sensor may be mounted below according to the location of the support structure for handling a payload.

One or a plurality of vision cameras and/or other sensors (such as sonar) may be mounted to a bottom of the robot 400 in a bottom-facing direction to identify the landing station and to detect obstacles before landing.

The robot 400 may incorporate an autopilot module board and a high-level computer board to process images received by the robot, and a memory to store routes or paths of movement, lookup tables and the like. The autopilot and the high-level computer board form together the local control module (LCM) for the robot.

The robot 400 may be configured to be capable of obstacle avoidance based on an onboard sensor (e.g. sonar, LIDAR etc.) response using, for example, MAVLink protocol. There are two kinds of obstacles which are static obstacles and dynamic obstacles. Static obstacles are the obstacles which are previously known and defined as the constraints in the path planning algorithm. Dynamic obstacles are the obstacles that are appeared due to external disturbances, such as humans, other agents and moving objects.

A pre-existing obstacle can be taken into account during the trajectory generation. In the case of a moving intruder into an agent's path, the robot 400 may perform evasive maneuver based on at least one onboard sensor. If the evasion cannot be successfully performed, and the agent suffers damages, the agent may be configured to perform or receive instructions from the ground control station to perform a homing maneuver or a safety landing to control station or other predetermined homing location based on the degree of damages to the agent. The robot 400 can have onboard positioning sensors.

In general, a sensor may include one or more of GNSS, UWB, RPS, MCS, optical flow, infrared proximity, pressure and sonar, or IMU sensors. GNSS is an outdoor positioning system which does not require additional setup. GPS can include also the RTK (Real Time Kinematics), CPGPS, and differential GPS. RTK is a technique used to enhance the precision of position data derived from satellite-based positioning systems, being used in conjunction with a GNSS. RTK GNSS can have a nominal accuracy of 1 centimeter horizontally +1-2 ppm and 2 centimeters vertically +1-2 ppm. RTK GPS is also known as carrier-phase enhancement GPS. UWB (ultra wide band) range sensing module can overcome the multipath effect of GPS. The UWB can be used as a positioning system to complement the GPS. PulsON® UWB platform provides through-wall localization, wireless communications, and multi-static radar. An RPS (Radio Positioning System) is a local positioning system, which can be a good alternative to replace GPS sensors in places where GPS signals may be weak. An MCS (Motion Capture System) may be suitable for small area coverage and precise control. VICON LA, CA, USA can provide suitable MCS systems for use with agent 100, as well as OptiTrack™ Systems by NaturalPoint, Corvallis, Oreg. USA. An onboard optical flow sensor can be a downward looking mono camera that calculates horizontal velocity based on image pixels, which can serves as a backup solution to hold agent 100 position when other systems are down.

An onboard infrared proximity sensor may be incorporated to sense other agents or obstacles nearby. Onboard pressure sensor and sonar sensor can provide height information. Onboard Inertial Measurement Unit (IMU) sensors (including, without limitation, an accelerator, a gyrometer, and a magnetometer) can be used to estimate the attitude of agent, including roll, pitch, and yaw. A LIDAR sensor also may be used to measure distances precisely.

By adjusting the distance between each time step, the velocity and acceleration can be controlled. (velocity is the derivative of position with respect to time, and acceleration is the derivative of velocity with respect to time). Several positioning system such as Radio Frequency Triangulation (RFT), GPS, motion capture cameras, ceiling tracking can be used to give the absolute position of each agent. This information can be fed to a ground control device or the robot 400 depending on the positioning system being used.

If the information is fed to the ground control device (when using RFT, motion capture) or motion capture cameras), the ground control device will send the position of each agent to the on-board controller of each agent respectively (position of agent 1 to agent 1, position of agent 2 to agent 2, etc.). If the information is fed to the on-board controller (when using RFT or GPS), the on-board controller will send its own position to the ground control device. Hence, the ground control device will always know the absolute position of each agent, while each agent will only know its own absolute position and, at certain distance apart, its neighbor.

In an embodiment, a ground control device may be used to generate the waypoints for the agents, communicate with the agents, monitor the agents, or update and alter the memory of each agent.

Since the agent runs its mission based on the path stored in its own memory, after generating the path, the ground control device may be able to access the memory of each agent, and alter the paths or waypoints of the agents if necessary. Depends on the positioning system that is being used, the ground control device may either send the position information to the agents, or request for the agent's position.

In an embodiment, an agent controlling device controlling an agent may be configured to, control the agent to:
communicate (send and/or receive) its position to the ground control device;
broadcast its position on low power so that only the nearby agents would pick the signal;
do evasive maneuvers when it is getting too close to the other agents;
avoid obstacles that are blocking its path;
individually decide to activate safety landing procedures when there is a fault

The agent controlling device may be adapted to be used in any platform, including other types of UAV or unmanned ground vehicles, unmanned underwater vehicles. An onboard computer or controller of each of the plurality of agents may be configured to control each agent to perform navigation based on the commands it receives from a ground station, as well as from other sources, such as other agents or ground stations. Onboard operating system/software should perform all onboard tasks in real time (e.g. sensor reading, attitude estimation, and actuation). Typically, individual agent may require calibration at start-up, for example, automatically at boot time for the onboard sensor. Certain positioning systems and maneuvers may require additional calibration efforts, for example, before a payload delivery task is initiated, or before a performance commences.

In all the embodiments, an agent can be controlled, for example, in one of four (4) modes:
(1) standby mode, in which agent is powered-on, and is standing-by for mission commands;
(2) manual stabilized mode, in which agent is controlled manually by a human pilot (e.g., during troubleshooting);
(3) autonomous mode, in which agent is carrying out its task autonomously (for example, using waypoint navigation); and
(4) failsafe mode in which agent encounters a problem and, after deciding to terminate the mission, the agent can return to the homing position or perform a safety landing.

Typically, agent dynamics are determined by agent form factor and actuator design. When an external disturbance causes an agent to oscillate or be perturbed, the effect is compensated by the onboard computer, which senses attitude changes and performs the required feedback action.

The degrees of freedom, or the number of independent parameters that define its configuration, which an agent possesses, depends of the type of agent. For purposes of illustration, an airborne agent, such as a quadcopter, will be hereinafter used as an example of agent 100. An agent can be holonomic or non-holonomic, in which holonomic means the controllable degrees of freedom (DOF) equals the total degrees of freedom. In general, an agent may configured to be capable of a spatial maneuver (2D for ground robot with 3 DOF, and 3D for flying robot, with 6 DOF). An agent can be equipped with a health monitoring system that sends heartbeats, and system status data including error status to the ground station. Issues such as malfunctioning components or sensor mis-calibration can be identified, agent may return to a pre-defined maintenance location, where the issues can then be addressed.

In accordance with the present embodiments, an agent may be configured to control multiple flying agents autonomously; the ability to navigate agents in a constrained environment; and the ability to navigate flying agents precisely, for example, within 1 cm. of an assigned waypoint, when indoors, or when outdoors where GPS signals are weak.

In an embodiment, a system for performing a task in an operating region may be configured to incorporate a collision feature module in an agent. For example, a second communication module is used to broadcast the position and unique id of each agent. When an agent receives the position data of another agent, the on-board controller may be configured to calculate the distance and relative position between them. Each agent has its own safety distance or boundary (“safe distance”). When the distance between agents is lower than the safety boundary, if both agents have the same priority, both of them will move away from each other before continuing their own path. Otherwise, the agent with lower priority will move away, giving way to the one with higher priority (higher priority is given to the agent that is carrying a payload, highest priority is given to the agent with failures which is restricted in its ability to avoid other obstacles or to maneuver). The safety boundary can be changed depend on the environment.

By altering the transmitter power, and the receiver threshold of this communication module, the agent will only receive and calculate the information when another agent is close enough. Hence, the computational requirement is highly reduced.

Optimal trajectories within the same region can be generated without collision, and the agents are allowed to move across sub-regions. Anti-collision maneuvers can also be executed for agents from different sub-regions. The time-varying region dividers can also be configured to be automatically generated in real-time based on formation patterns and desired routes.

For unmanned systems, which parts of the state space are safe to operate during the flight is a question that needs to be addressed, even when the dynamics of the unmanned system are completely understood or assumed known. With FDEA, a first approach is to address how to generate dynamically feasible, collision-free coordination for large quantity of multiple agents. FDEA for multiple agent control may be applied in a hierarchical fashion. In order to generate dynamically feasible trajectories while fully utilizing each agent's dynamical resources, FDEA can provide the multi-agent coordination framework. Based on the dynamical model of each agent, a full dynamical envelope can be calculated at each control sampling time to generate the boundaries of the dynamical envelope for every possible agent system input. Based on the boundaries of the envelope, a safe maneuver envelope can be detected, which is the part of the state space for which safe operation of the agent can be guaranteed, without violating external constraints. An optimization may then be performed to generate the optimal inputs for each agent to minimize the total cost function for coordination of the whole group.

In addition, when the flight envelope is known, the maneuvering space can be presented to the ground control station (GCS). A limitation of the conventional definition of flight envelope can be that only constraints on quasi-stationary agent states are taken into account, for example during coordinated turns and cruise flight. Additionally, constraints posed on the aircraft states by environment are not part of the conventional definition. Agent dynamical behavior especially for some agile/acrobatic agents, such as, for example, a helicopter or a quadcopters, can pose additional constraints on the flight envelope.

For example when an agent flies fast forward, it cannot immediately fly backwards. Therefore, an extended definition of the flight envelope is required for an agent, which can be called Safe Agent Maneuver Envelope (SAME). A Safe Agent Maneuver Envelope is the part of the state space for which safe operation of the agent can be guaranteed and external constraints may not be violated. The Safe Agent Maneuver Envelope can be defined by the intersection of four envelopes. First, a Dynamic Envelope, which can include constraints posed on the envelope by the dynamic behavior of the agent, for example, due to its aerodynamics and kinematics. Second, a Formation Envelope, which can include constraints due to the inter-agents connections, can be significant when an agent is in a formation flight group, depending on its neighborhood agents' state and the formation topology. There may be additional constraints like inter-agents collision avoidance, formation keeping and connection maintaining. Third, a Structural Envelope, which can be constraints posed by the airframe material, structure and so on. These constraints are defined through maximum loads that the airframe can take. Fourth, an Environmental Envelope, which can include constraints due to the environmental in which the agent operates, such the wind conditions, constraints on terrain, and no-go zones. These four envelopes can be put into the same MPC (Model Predictive Control) formation flight framework in which the constraints will be time-varying during the online optimization process. Dominating the dynamics during an extreme formation maneuver by an airborne agent can be the dynamic envelope and the formation envelope. Constraints posed on the agent by dynamic flight and formation envelopes can be, for example, a maximum bank angle when it flies forward.

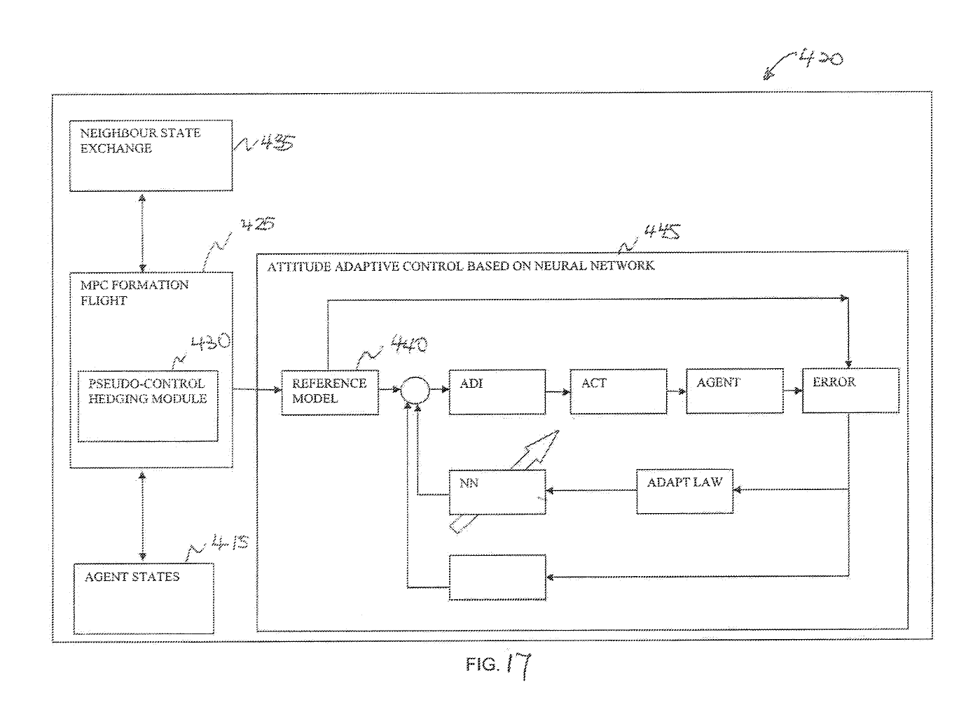

These constraints may prevent the agent from engaging a potentially hazardous phenomenon. These kinds of constraints are not fixed, but are dependent on the agent's flight states and the formation states. Thus, in the formation flight MPC formulation these envelops can be measured during flight, and accordingly the constraints can be calculated, which result in an adaptive MPC formation flight scheme. The safe operating set on which the time-varying states constraints are based can be calculated online in MPC. In addition, the PCH algorithm is also implemented in the MPC formation flight optimization framework as illustrated with respect to FIG. 17. The PCH technique is well-known in the art, for example, in Pseudo-Control Hedging: A New Method For Adaptive Control, Eric N. Johnson, et al., Advances in Navigation Guidance and Control Technology Workshop, Redstone Arsenal, Ala., Nov. 1-2, 2000, which is incorporated by reference herein in its entirety.

FIG. 17 is a block diagram of an MPC formation flight planner 420 with attitude adaptive control illustrating a Model Predictive Control framework using pseudo-control hedging with a neural network adaptation stage. MPC Formation flight planner 425 having a pseudo-control hedging module 430 can use agent states 415 and neighboring agent states (e.g., formation information) 435 as input. The flight plan is received from planner 420 by reference model 440 of neural network-based attitude adaptive control 445. Based on the desired formation position and the states of the agent, the MPC controller calculates the safe operating envelop which determines the instantaneous flight state constraints for the real-time optimization, then MPC controller generates the desired optimal attitude angles of the agent body axis which are the inputs for the bottom layer adaptive NN controller.

An embodiment of the agent may be configured to include a formation flight framework for an agent which explores the advantages of MPC while being able to control fast agent dynamics. Instead of attempting to implement a single MPC as the formation flight control system, the proposed framework employs a two-layer control structure where the top-layer MPC generates the optimal states trajectory by exploiting the agent model and environment information, and the bottom-layer robust feedback linearization controller is designed based on exact dynamics inversion of the agent to track the optimal trajectory provided by the top-layer MPC controller in the presence of disturbances and uncertainties. These two layer controllers are both designed in a robust manner and running parallel but at different time scales. The top-layer MPC controller which is implemented using the open source algorithm runs at a low sampling rate allowing enough time to perform real-time optimization, while the bottom-layer controller performs at a much higher sampling rate to respond the fast dynamics and external disturbances.

The piecewise constant control scheme (input hold) and the variable prediction horizon length are combined in the top-layer MPC. The piecewise constant control allows the real-time optimization occurring at scattered sampling time without losing the prediction accuracy. Moreover, it reduces the number of control variables to be optimized which helps to ease the workload of the real-time formation flight optimization. The variable prediction horizon length is suitable for the formation flight control problem which can be regarded as a transient control problem with a predetermined target set (the specified formation position). Compared to the fixed prediction horizon length, the variable prediction horizon version further saves the computational energy, for example when the follower agent is already near the formation position, the prediction horizon length needed will be much shorter.

The connection between the upper layer MPC flight control and the bottom layer attitude control is the “Pseudo-Control Hedging (PCH)” module, and the real-time state constraints adjustment based on the reachability analysis. Based on the idea of PCH, the method proposed not only prevents the adaptive element of an adaptive control system from trying to adapt to the input characteristics (the motor characteristics like saturation), but also forms a safe maneuver envelope determination through reachability analysis which makes the formation flight safer.

The pseudo-control signal for the attitude control system is received by the approximate dynamic inversion module. The pseudo-control signal includes the output of reference model, the output of proportional-derivative compensator acting on the reference model tracking error, and the adaptive feedback of neural network. Approximate dynamic inversion module is developed to determine actuator (torque) commands, which provokes a response in agent 445. Based on agent response in view of the reference model, an error signal is generated. Neural network (NN) can be a Single Hidden Layer (SHL) NN. SHL NN are typically universal approximators in that they can approximate nearly any smooth nonlinear function to within arbitrary accuracy, given a sufficient number of hidden layer neurons and input information. Adaptation law can be modified according to the learning rates, a modification gain, and a linear combination of the tracking error and a filtered state.

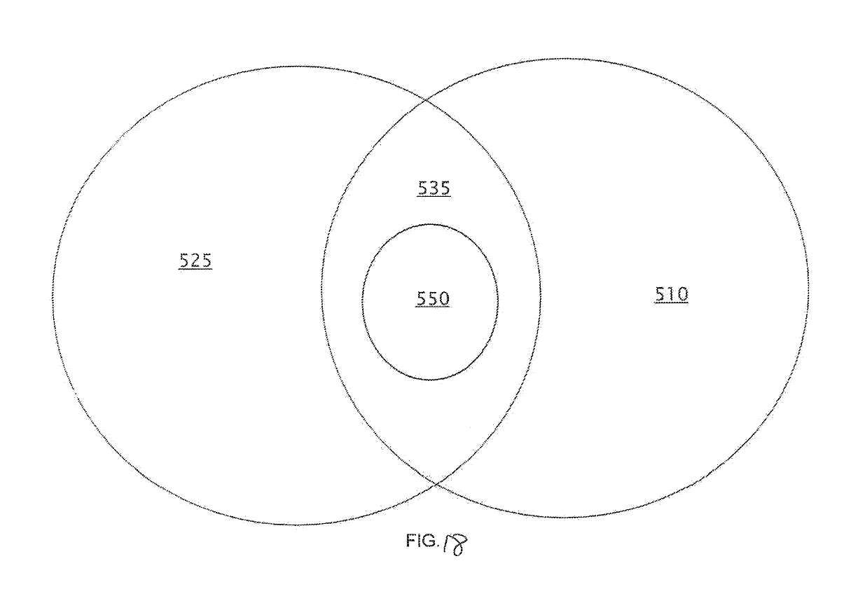

An agent may be characterized by many dynamic resources like pitch speed, roll speed, forward acceleration/speed, backward acceleration/speed, etc. Normally extreme usage of one resource will limit the use of other resources, for example, when an agent flies forwards in full speed (accompanied by large pitch angle), then it is very dangerous for it to perform a large roll. In order to prevent such LOC in an agent, the states constraints can be calculated online based on the safe operating set referred to in FIG. 18 which will be described below.

Reachable set analysis can be an extremely useful tool in safety verification of systems. The reachable set describes the set that can be reached from a given initial set within a certain amount of time, or the set of states that can reach a given target set given a certain time. The dynamics of the system can be evolved backwards and forwards in time resulting in the backwards and forwards reachable sets respectively. For forwards reachable set, the initial conditions can be specified and the set of all states that can be reached along trajectories that start in the initial set can be determined. For the backwards reachable sets, a set of target states can be defined, and a set of states from which trajectories start that can reach that target set can be determined. In general, the safe maneuvering/operating envelope for UAV dynamics may be addressed through reachable sets.

In FIG. 18, forward reachable set can be represented by set 510, backwards reachable set can be represented by set 525, and the safe operating set can be shown by the intersecting set 535. In set 550, the minimum volume ellipsoid covering the safe operating set is shown. Using the Multi-Parametric Toolbox (MPT), N-step reachable sets can be computed for linear and hybrid systems in a Model Predictive Control (MPC) framework, assuming the system input either belongs to some bounded set of inputs, or when the input is driven by some given explicit control law. MPT ver. 3 is an open-source, MATLAB-based toolbox for parametric optimization, computational geometry, and model predictive control. MPT ver. 3 is described in M. Herceg, M. Kvasnica, C. N. Jones, and M. Morari. Multi-Parametric Toolbox 3.0. In Proc. of the European Control Conference, pages 502-510, Zurich, Switzerland, Jul. 17-19, 2013, which is incorporated herein by reference in its entirety. MPT, ver. 3 is available at http://control.ee.ethz.ch/˜mpt/3/.

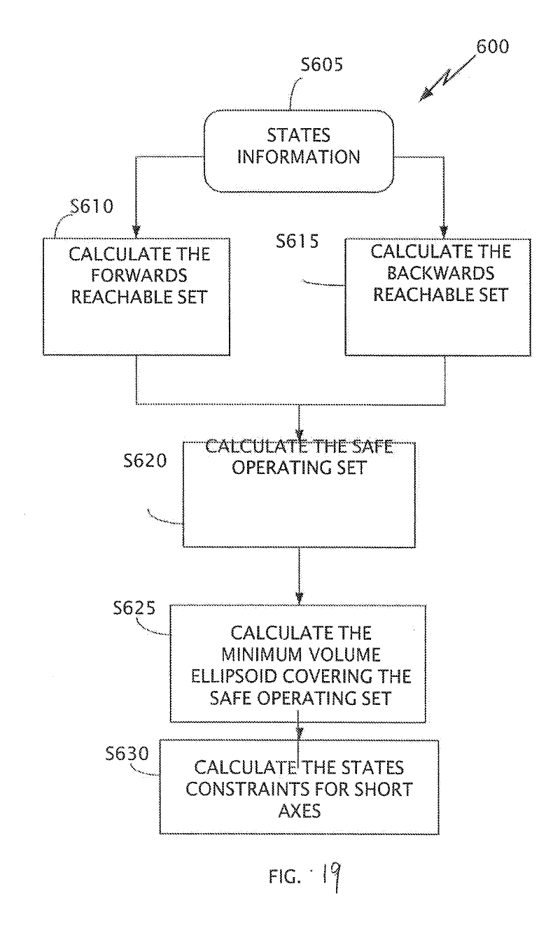

FIG. 19 is a flowchart illustrating a method 600 for determining the states constraints. By taking the agent states information S605, a forwards reachable set can be calculated S610, and a backwards reachable set can be calculated S615. From the reachable sets obtained at S610, S615, the safe operating set can be calculated S620. With the safe operating set calculated, the minimum volume ellipsoid covering the safe operating set can be determined S625, and the states constraints for the short axes of the ellipsoid can be obtained S630.

Finding the minimum volume ellipsoid E_{S} that contains the safe operating set S={x₁, . . . , xₘ}⊂

Rn can be determined if ellipsoid covers S if and only if it covers its convex hull, so finding the minimum volume ellipsoid E_{S} that covers S is the same as finding the minimum volume ellipsoid containing a polyhedron. In S630, the minimum volume ellipsoid E_{S} that contains the safe operating set can be calculated using convex optimization, producing the short axes.

An agent may be further configured to detect and avoid obstacles. Vision is used as the primary sensor for detecting obstacles. Multiple vision systems are attached to the agent to enable 360° viewing angle. The processed image can be used to determine the obstacle position, size, distance, and time-to-contact between the agent and the obstacle. Based on the information, the On-board Control Module will do the evasive maneuver before continue following the path.

Additional ranging sensor (e.g. but not limited to, sonar, infrared, Ultra-Wideband sensors) is used to complement the visual sensor. By themselves, the ranging sensor is not enough to detect complex or far-away obstacles, but they will be a crucial addition, especially at short range to increase the obstacle detection rate. When the system is used for flying agents, the agents can be flown above most of the low-medium height obstacles, hence reducing the number of obstacles to be detected

In the above embodiments, the methods for Full Dynamics Envelope Analysis (FDEA) are responsible for collision-free trajectory generation for multiple-agent scenario. From FIG. 8, above, the sub-region information from the FSRD is made available 740 to the FDEA method 200. Each sub-region information describes the spatial region boundaries, and the number of agents in that sub-region. In addition, the dynamics of agents, i.e. maximum allowable speed, maximum allowable acceleration, and other constraints are defined by the users. The mission/show waypoints together with the timings are also provided to the FDEA method 200. The FDEA method 200 takes into consideration the full dynamics of the agents, the agents' feasible operating envelope, and spatial constraints to generate the optimized (in terms of getting from one point to another in the shortest time) and collision-free trajectories. The order of complexity of this trajectory generation increases exponentially with respect to the number of agents involved. Hence, the preceding FSRD method 60 prepares and subdivides the overall spatial regions so that the optimization is feasible for the FDEA method 200. The outputs from the FDEA method 200 can be the trajectories for each agent, that is, a list of waypoints at fixed time-step, between 1 Hz and 50 Hz or more, depending on the scenario requirements. These waypoints can be broadcast to agents from the ground control station, or uploaded to the agents' onboard computer directly.

Using FSRD and FDEA methods can permit formation or swarm behaviors in complex, tightly constrained clusters or a fleet of agents, substantially without collision, whether with predetermined or evolving waypoints and trajectories. Agents of different types may be deployed simultaneously in a cluster or clusters, or in a fleet, exhibiting goal- or mission-oriented behavior.

Applications for systems and methods disclosed herein may include, without limitation, food delivery within a restaurant, logistics delivery as in a warehouse, aircraft maintenance and inspection, an aerial light performance, and other coordinated multiple agent maneuvers, which are complex, coordinated, and collision free. In one embodiment, agents, which may be ground or aerial agents, may implemented in a restaurant to serve food to the dining tables in the restaurant from the kitchen. Multiple agents can maneuver within a tight, constrained space, in order to deliver food and beverages to customers at the dining tables. An FSRD technique may be used to reduce the computational complexity of the constrained space with numerous agents. An FDEA technique may be used to generate collision-free trajectories for the agents to maneuver inside or outside of the restaurant. In some embodiments, sensors at the dining tables, may have unique IDs, which can guide the agents to deliver the food to the correct table. A home base would also be an autonomous landing and battery charging solution in or near the kitchen.

An agent may be further configured to perform autonomous takeoff and landing. In an example, after reaching its destination, in order to improve the landing accuracy, additional visual cues are added on each destination either at the ceiling or at the floor or somewhere in between (e.g. unique pattern, QR codes, color, LED that is flashing in unique sequences). The agent will then look for these unique cues, and align itself. The aligning part is crucial especially to flying agent before it starts the landing sequence. During the landing sequence, the flying agent will keep re-arranging itself to the visual cues.

Additional vision and ranging system may be placed on the agent to detect the sudden appearance of an obstacle during the landing sequence. Whenever there is a sudden change in distance between the agent and the ground as well as the agent and the ceiling, the agent will stop descending. The agent can detect whether the disturbance has been gone by comparing the current distance between the ceiling to the ground with the distance before the disturbance occurred. After the disturbance has been gone, the agent will continue the landing sequence. The same obstacle detecting system can be used during the takeoff sequence as well.

In some embodiments, an agent may be configured to hover over or can land at a predefined location (kitchen table, dining tables, service tables, etc.) to either receive payload or to deliver payload. Agents may also sense and avoid moving or static obstacles (such as furniture, fixtures, or humans) while following its pre-defined route in delivering a payload to its predefined destination or returning to home base. Multiple agents can act in a unison formation or in a swarm to deliver edibles and utensils to a diner's table, and later, to bus the table. Advantages of aerial agents in restaurants include the utilization of ceiling space in the restaurant that is 99% unused, the ability to cater to restaurants that have different ground layouts and uneven grounds, and no need for expensive and space-wasting conveyor belts or food train systems. Rather than have servers bustle back-and-forth from kitchen to table, aerial agents can deliver food to the appropriate table from a central waiting area, which may be detached from the kitchen.

In an embodiment, a system for performing a task in a constrained region such as a warehouse, agents (could be, but not limited to, flying or ground robots) could be utilized to deliver goods from one location to another within, or outside, a warehouse. Aerial or ground agents or both could be used to transport the payload. Agents could utilize the full 3-dimensional spatial region of the warehouse to achieve its objective of transporting payloads. The FSRD method according to the embodiments can be used to reduce the computational complexity of generating collision-free trajectories. In addition, the FDEA method can be used to generate collision-free trajectories for agents to maneuver within or outside the warehouses. In a specific warehouse application of palletizing goods in or outside warehouses, agents could self-organize the goods on the pallets given the characteristics (dimensions and/or weight) of the goods and/or the dimensions of the pallet to determine the optimal layout and arrangement autonomously. When pallets are fully packed and organized, ground agents (such as, but not limited to, unmanned forklifts) could load the pallets onto the container vehicles or trucks. In general, agents would also work cooperatively with different types or kinds of agents to achieve a single mission or multiple missions.

In a system of multiple agents performing a performance, or forming of agents to create swarming effect or communication mesh networks. The two main advantages of methods described in the above embodiments is that the methods can be used to increase the speed of the agents reaching their real-time or pre-determined waypoints within the formation and in a computationally feasible manner for a large number of agents. In the performance, formations of agents can be pre-determined or determined in real-time. For a performance, agents could take up positions in a formation to create visual displays or for other purposes such as swarming or communication mesh networks. Agents may also work cooperatively with different types or kinds of agents to achieve a single mission or multiple missions in order to achieve goals of the performance.

Monitoring and additional safety features may be incorporated in systems according to the above embodiments. For example, the communication interfaces between a ground control device and an agent controlling device of an agent may be used to send the agent's status for monitoring (e.g. battery status, deviation from the planned path, communication status, motor failure, etc). Based on the information, different safety procedures will be taken. Safety landing procedures may include returning to home base position or to land safely immediately at a clear spot at its current position. In an example, an agent will not start the mission if the battery level is not sufficient to complete the mission or task, with a certain buffer time. In the event of communication failure, the agent will maintain its position. If is not connected within certain time, the flying agent will engage the safety landing procedure. Otherwise the agent will continue its mission. The ground control device may be configured to monitor the distance between desired position and current position of an agent. If the distance is higher than a predetermined threshold, the flying agent will engage the safety landing procedure. A current sensor may be placed on each motor to determine whether there is a failure in the motor, or there is an external disturbance that prevents the agent from moving. When there is no current flowing to a motor, there is a motor failure which would make the flying agent to engage the safety landing procedure.

When the current flowing to the motors is too high, it means that there is an external disturbance which prevents the agent from moving. In that case, the agent will engage the safety landing procedure. There may be flight redundancies in the design of the agent. If one of the propellers or thrusters has failed to operate, other propellers or thrusters will take on additional weight of the inoperative propellers such that the agent does not go out of control. There may be dual power source with dual processing chips for the agent's on-board controller to mitigate against any possible single point of failure. The safety auto-landing procedure is done by slowly reducing the throttle (motor speed), so that in the case of a flying agent, it would not suddenly drop to the ground. An emergency stop is used in a case of catastrophic disaster which may require the whole system to stop. In that case, the ground control device may be configured to send a signal to control all the agents to perform a safety landing procedure.

In the embodiments, the system may be applied in a variety of situations, such as, but not limited to, in a restaurant or banquet hall where multiple agents are coordinated autonomously to deliver food or drinks from the kitchen or drinks bar to tables or seats, and/or to transport used dishes and crockery from the dining table to the kitchen. Other applications may also include moving goods in a warehouse from one point to another, such as from the conveyor belts to the pallets for shipment by trucks. Further, the system may be for executing formations with the autonomous agents, either underwater, on ground or in the sky. Still further, the system may include inspecting of aircrafts in hanger with multiple agents using a video recorder or camera attached to the agents.

While the above detailed description has described novel features as applied to various embodiments, it will be understood that various omissions, substitutions, and changes in the form and details of the illustrated devices or algorithms can be made without departing from the scope of the invention. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope. Accordingly, the present disclosure is not intended to be limited by the recitation of the above embodiments.

1. A system for performing a task in an operating region, the system comprising:
a plurality of agents, wherein each of the plurality of agents has a start position in the operating region and an end position in the operating region; and
a ground control device comprising:
a processor; and
a storage device for storing one or more routines which, when executed under control of the processor, control the ground control device to:
divide the operating region into a plurality of sub-regions based on the start and end positions of the plurality of agents so as to assign ones of the plurality of agents to each sub-region, wherein a number of the ones of the plurality of agents in each sub-region is smaller than a number of the plurality of agents in the operating region;
generate sub-region data of each of the sub-regions; and
generate a plurality of paths of movement based on the sub-region data of the sub-regions for allowing the plurality of agents to move in the operating region to perform the task.

2. The system of claim 1, wherein the ground control device is configured, under control of the processor to divide the operating region by iteratively dividing the operating region to generate a new array of sub-regions.

3. The system of claim 1 or 2, wherein the ground control device is configured, under control of the processor to:
analyze dynamics of the ones of the plurality of agents in each sub-region;
define operating envelopes for the plurality of agents based on the sub-region data and the dynamics of the plurality of agents; and
generating a plurality of waypoints for each of the plurality of agents based on the operating envelopes.

4. The system of claim 3, wherein the operating envelopes include spatial constraints of the operating region.

5. The system of claim 1, wherein each of the plurality of agents includes at least one sensor and at least one actuator.

6. The system of claim 5, wherein the ones of the plurality of agents is a cluster of coordinated agents configured to operate to exhibit a behavior in response to the actuator, wherein the behavior is coordinated swarming behavior.

7. The system of claim 5, wherein the ones of the plurality of agents is a cluster of coordinated agents configured to operate to exhibit a behavior in response to the actuator, wherein the behavior is coordinated formation behavior.

8. The system of claim 1, wherein the operating region is a constrained space.

9. The system of claim 1, wherein the ground control device is configured, under control of the processor to receive positional information of each of the plurality of agents.

10. The system of claim 1, wherein each of the plurality of agents include:
a first communication interface for communicating with the ground control device;
a second communication interface for communicating with neighbouring ones of the plurality of agents;
a controller coupled to the first and second communication interfaces, and including a device identifier code; and
a storage device for storing one or more routines which, when executed under control of the controller, control each of the agents to:
receive a position and a device identifier code of neighbouring ones of the plurality of agents;
calculate a distance and a relative position between one of the plurality of agents and neighbouring ones of the plurality of agents; and
generate a path of movement for the one or neighbouring ones of the plurality of agents based on a priority level associated with each of the plurality of agents.

11. The system of claim 1, wherein each of the plurality of agents is adapted for handling a payload.

12. The system of claim 10, wherein the ground control device is configured, under control of the processor, to send a further task to an agent configured to perform or performing a current task stored in the storage device of the agent, wherein the further task replaces the current task.

13. A method of controlling a plurality of autonomous agents in an operating region, the method comprising:
dividing the operating region into a plurality of sub-regions based on the start and end positions of the plurality of agents so as to assign ones of the plurality of agents to each sub-region, wherein a number of the ones of the plurality of agents in each sub-region is smaller than a number of the plurality of agents in the operating region;
generating sub-region data of each of the sub-regions; and
generating a plurality of paths of movement based on the sub-region data of the sub-regions for allowing the plurality of agents to move in the operating region to perform the task.

14. The method of claim 13, further comprising:
iteratively dividing the operating region to generate a new array of sub-regions.

15. The method of claim 13, further comprising:
analyze dynamics of the ones of the plurality of agents in each sub-region;
define operating envelopes for the plurality of agents based on the sub-region data and the dynamics of the plurality of agents; and
generating a plurality of waypoints for each of the plurality of agents based on the operating envelopes.

16. The method of claim 15, wherein the operating envelopes include spatial constraints of the operating region.

17. The method of claim 12, further comprising:
generating a plurality of coordinated trajectories for the plurality of agents.

18. An agent controlling device comprising:
a first communication interface for communicating with a ground control device in a system of agents configured for performing a task in an operating region;
a second communication interface for communicating with neighbouring ones of the plurality of agents;
a controller coupled to the first and second communication interfaces, and including a device identifier code; and
a storage device for storing one or more routines which, when executed under control of the controller, control the one of the plurality of agents to:
receive a position and a device identifier code of each neighbouring one of the plurality of agents;
calculate a distance and a relative position between the one of the plurality of agents and the neighbouring one of the plurality of agents; and
generate a path of movement for the one or neighbouring ones of the plurality of agents based on a priority level associated with each of the plurality of agents.

19. A ground control system for controlling a plurality of agents in a system for performing a task, the ground control system comprising:
a processor; and
a storage device for storing one or more routines which, when executed under control of the processor, control the ground control device to:
divide the operating region into a plurality of sub-regions based on the start and end positions of the plurality of agents so as to assign ones of the plurality of agents to each sub-region, wherein a number of the ones of the plurality of agents in each sub-region is smaller than a number of the plurality of agents in the operating region;
obtain, for generation of a plurality of paths of movement by a path generator, sub-region data of each of the sub-regions.

20. The ground control system of claim 19, further configured, under control of the processor to iteratively divide the operating region into a new array of sub-regions.

21. The ground control system of claim 20, further configured, under control of the processor to generate a plurality of paths of movement based on the sub-region data of the sub-regions for allowing the plurality of agents to move in the operating region to perform the task.

22. The ground control system of claim 19, further configured, under control of the processor to:
analyze dynamics of the ones of the plurality of agents in each sub-region;
define operating envelopes for the plurality of agents based on the sub-region data and the dynamics of the plurality of agents; and
generating a plurality of waypoints for each of the plurality of agents based on the operating envelopes.

23. The ground control system of claim 19, further configured, under control of the processor, to send a further task to an agent configured to perform or performing a current task stored in the storage device of the agent, wherein the further task replaces the current task.

24. An autonomous aerial robot for handling a payload in a system comprising a plurality of autonomous aerial robots configured for receiving instructions from a ground control system for performing a task in an operating region, the autonomous aerial robot comprising:
a support member adapted for handling a payload;
a first communication interface for communicating with a ground control device;
a second communication interface for communicating with neighbouring ones of the plurality of robots;
a controller coupled to the first and second communication interfaces, and including a device identifier code; and
a storage device for storing one or more routines which, when executed under control of the controller, control the autonomous aerial robot to:
receive a position and a device identifier code of the neighbouring ones of the plurality of robots;
calculate a distance and a relative position between the autonomous aerial robot and each of the neighbouring ones of the plurality of robots; and
generate a path of movement for the autonomous aerial robot based on a priority level associated with each of the plurality of robots.

25. The autonomous aerial robot of claim 24, comprising at least one sensor and at least one actuator.

26. The autonomous aerial robot of claim 23, wherein the at least one sensor is a force sensor for detecting a change in a weight of the autonomous aerial robot, wherein the autonomous aerial robot is configured, under control of the controller, to generate or reduce a lift-up force to compensate the change in the weight.
